(19) United States
(12) Patent Application Publication
(10) Pub. No.: US 2011/0270824 A1
(43) Pub. Date: Nov. 3, 2011

(54) COLLABORATIVE SEARCH AND SHARE

(75) Inventors: Meredith June Morris, Bellevue, WA (US); Daniel J. Wigdor, Seattle, WA (US); Vanessa Adriana Larco, Kirkland, WA (US); Jarrod Lombardo, Bellevue, WA (US); Sean Clarence McDirmid, Beijing (CN); Chao Wang, Beijing (CN); Monty Todd LaRue, Redmond, WA (US); Erez Kikin-Gil, Redmond, WA (US)

(73) Assignee: MICROSOFT CORPORATION, Redmond, WA (US)

(21) Appl. No.: 12/771,282

(22) Filed: Apr. 30, 2010

(51) Int. Cl. G06F 3/048; G06F 17/30

(52) U.S. Cl. 707/722; 715/753; 715/702; 707/772; 715/764; 715/716; 707/E17.014; 715/863; 715/830; 715/769

(57) ABSTRACT

Collaborative search and share is provided by a method of facilitating collaborative content-finding, which includes displaying a toolbar user interface object for each user that not only allows each user to perform content-finding but also increases awareness of each user to the activities of other users. The method further includes displaying content results as various disparate image clips that can easily be shared, moved, etc. amongst users.

### BACKGROUND

Groups of computer users often have shared information needs. For example, business colleagues conduct research relating to joint projects and students work together on group homework assignments.

However, many computing devices are designed for a single user. Consequently, it may be difficult to coordinate joint research efforts or other collaborative projects on this type of computing device. Such computing devices do not facilitate awareness of all group member activities or efficiently coordinate joint tasks. For example, when attempting to conduct research through a web search on multiple computing devices, redundant tasks may be performed due to the lack of information disseminated between the computing devices. Furthermore, simultaneous participation in various tasks may not be possible between multiple computing devices.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Furthermore, the claimed subject matter is not limited to implementations that solve any or all disadvantages noted in any part of this disclosure.

According to one aspect of the disclosure, a method of facilitating collaborative content-finding includes displaying a toolbar user interface object for each user that not only allows each user to perform content-finding but also increases awareness of each user to the activities of other users. The method further includes displaying content results as various disparate image clips that can easily be shared, moved, etc. amongst users.

### BRIEF DESCRIPTION OF THE DRAWINGS

FIG. 1 shows a block diagram of an example touch-display computing system in accordance with an embodiment of the present disclosure.

FIG. 2 schematically shows an example of collaborative search and share in accordance with an embodiment of the present disclosure.

FIG. 3 schematically shows an example toolbar user interface object in accordance with an embodiment of the present disclosure.

FIG. 4 schematically shows an example browser window in accordance with an embodiment of the present disclosure.

FIG. 5 shows a flow diagram of an example method of facilitating collaborative searching in accordance with an embodiment of the present disclosure.

FIG. 6 schematically shows another example of collaborative search and share in accordance with an embodiment of the present disclosure.

FIGS. 7-9 schematically show various examples of search result cards in accordance with embodiments of the present disclosure.

FIGS. 10-11 schematically show example travel logs in accordance with embodiments of the present disclosure.

### DETAILED DESCRIPTION

Collaborative web searching, browsing, and sensemaking among a user-group is disclosed herein. Collaborative searching can enhance awareness by informing each user of other users' activities. As such, division of labor is supported since overlap of work efforts is less likely to occur when users are aware of the other users' activities. As an example, business colleagues may utilize collaborative searching to find information related to a question that arises during the course of a meeting. As another example, students working together in the library on a joint homework project may utilize collaborative searching to find materials to include in their report. As yet another example, family members gathered in their home may use collaborative searching to explore topics such as researching joint purchases, planning an upcoming vacation, seeking medical information, etc. It can be appreciated that these examples are nonlimiting, and are just a few of the many possible use scenarios for collaborative searching.

Furthermore, collaborative searching may also enable shared searching to persist beyond a single session and support sensemaking as an integral part of the collaborative search process, as described in more detail herein. It will be understood that sensemaking is used to refer to the situational awareness and understanding that is created in complex and/or uncertain environments in order to make decisions. Collaborative search and share as described herein may also provide facilities for reducing the frequency of virtual-keyboard text entry, reduce clutter on a shared display, and/or address the orientation challenges posed by text-heavy applications when displayed on a horizontal display surface.

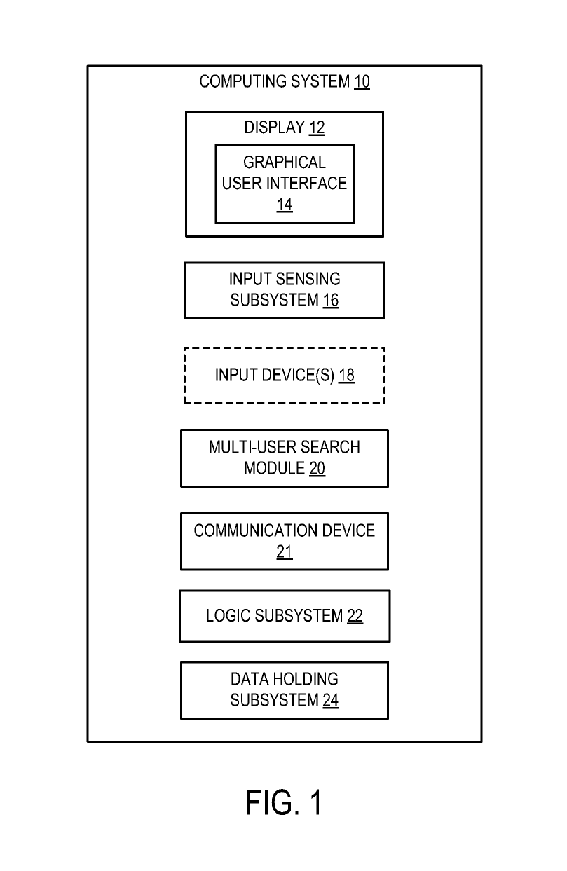

FIG. 1 shows a block diagram of an example computing system 10 configured to provide a collaborative search system. As will be described in more detail hereafter, such a collaborative search system facilitates collaborative searching in various ways, such as by displaying toolbars for each user that not only allows the user to perform searching but also keeps the user aware of the activities of other users. The collaborative search system further facilitates collaborative searching by displaying search results as various disparate image clips that can easily be shared, moved, etc. amongst the users, as described in more detail hereafter.

Computing system 10 includes a display 12 configured to present a graphical user interface (GUI) 14. The GUI may include, but is not limited to, one or more windows, one or more menus, one or more content items, one or more controls, a desktop region, and/or virtually any other graphical user interface element.

Display 12 may be a touch display configured to recognize input touches and/or touch gestures directed at and/or near the surface of the touch display. Further, such touches may be temporally overlapping. Accordingly, computing system 10 further includes an input sensing subsystem 16 configured to detect single touch inputs, multi-touch inputs, and/or touch gestures directed towards a surface of the display. In other words, the display 12 may be configured to recognize multi-touch input. It will be appreciated that input sensing subsystem 16 may include an optical sensing subsystem, a resistive sensing subsystem, a capacitive sensing subsystem, and/or another suitable multi-touch detector. Additionally or alternatively, one or more user input devices 18, such as mice, track pads, trackballs, keyboards, etc., may be used by a user to interact with the graphical user interface through input techniques other than touch-based input, such as pointer-based input techniques. In this way, a user may perform inputs via the touch-sensitive display or other input devices.

In the depicted example, computing system 10 has executable instructions for facilitating collaborative searching. Such instructions may be stored, for example, on a data-holding subsystem 24 and executed by a logic subsystem 22. In some embodiments, execution of such instructions may be further facilitated by a multi-user search module 20, executed by computing system 10. The multi-user search module may be designed to facilitate collaborative interaction between members in a user-group while the members work with outside information via a network, such as the Internet. The multi-user search module may be configured to present various graphical elements on the display as well as provide various functions that allow a user-group to perform a collaborative search via a network, such as the Internet, described in more detail as follows.

Further, the multi-user search module may be designed with the needs of touch-based interaction (e.g., touch inputs) in mind. Therefore, in some examples, the browser windows presented on the GUI may be moved, rotated, and/or scaled using direct touch manipulation.

The multi-user search module 20 may be, for example, instantiated by instructions stored on data-holding subsystem 24 and executed via logic subsystem 22. Logic subsystem 22 may include one or more physical devices configured to execute one or more instructions. For example, the logic subsystem may be configured to execute one or more instructions that are part of one or more programs, routines, objects, components, data structures, or other logical constructs (e.g., multi-user search module 20). Such instructions may be implemented to perform a task, implement a data type, transform the state of one or more devices, or otherwise arrive at a desired result. The logic subsystem may include one or more processors that are configured to execute software instructions. Additionally or alternatively, the logic subsystem may include one or more hardware or firmware logic machines configured to execute hardware or firmware instructions. The logic subsystem may optionally include individual components that are distributed throughout two or more devices, which may be remotely located in some embodiments. Furthermore the logic subsystem 22 may be in operative communication with the display 12 and the input sensing subsystem 16.

Data-holding subsystem 24 may include one or more physical devices configured to hold data and/or instructions executable by the logic subsystem to implement the herein described methods and processes (e.g., via multi-user search module 20). When such methods and processes are implemented, the state of data-holding subsystem 24 may be transformed (e.g., to hold different data). Data-holding subsystem 24 may include removable media and/or built-in devices. Data-holding subsystem 24 may include optical memory devices, semiconductor memory devices, and/or magnetic memory devices, among others. Data-holding subsystem 24 may include devices with one or more of the following characteristics: volatile, nonvolatile, dynamic, static, read/write, read-only, random access, sequential access, location addressable, file addressable, and content addressable. In some embodiments, logic subsystem 22 and data-holding subsystem 24 may be integrated into one or more common devices, such as an application specific integrated circuit or a system on a chip. In some embodiments, the data-holding subsystem may be in the form of a computer-readable removable media, which may be used to store and/or transfer data and/or instructions executable to implement the herein described methods and processes.

Collaborative multi-user computing system 10 may further include a communication device 21 configured to establish a communication link with the Internet or another suitable network.

Further, a display subsystem including display 12 may be used to present a visual representation of data held by data-holding subsystem 24. As the herein described methods and processes change the data held by the data-holding subsystem, and thus transform the state of the data-holding subsystem, the state of the display subsystem may likewise be transformed to visually represent changes in the underlying data. The display subsystem may include one or more display devices (e.g., display 12) utilizing virtually any type of technology. Such display devices may be combined with logic subsystem 22 and/or data-holding subsystem 24 in a shared enclosure, or such display devices may be peripheral display devices.

As a nonlimiting example, computing system 10 may be a multi-touch tabletop computing device having a large-form-factor display surface. As such, users located at the computing system (i.e., co-located users) can utilize collaborative search and share as described herein to facilitate group searching projects. The large size of the display of such a computing system allows for spatially organizing content, making it well-suited to search and sensemaking tasks. Nonlimiting examples of possible use scenarios include, but are not limited to, business meetings, classrooms, libraries, home, and the like.

It can be appreciated that embodiments of collaborative search and share may also be implemented to facilitate users who are not located at a shared computing device, but rather are located at different computing devices, which may be remotely located relative to one another. Since these users still face challenges of web searching, browsing, and sensemaking among a user-group, collaborative search and share can provide enhanced awareness by informing each user of other users' activities and can provide division of labor to minimize overlap of work efforts, even when the users are located at different devices.

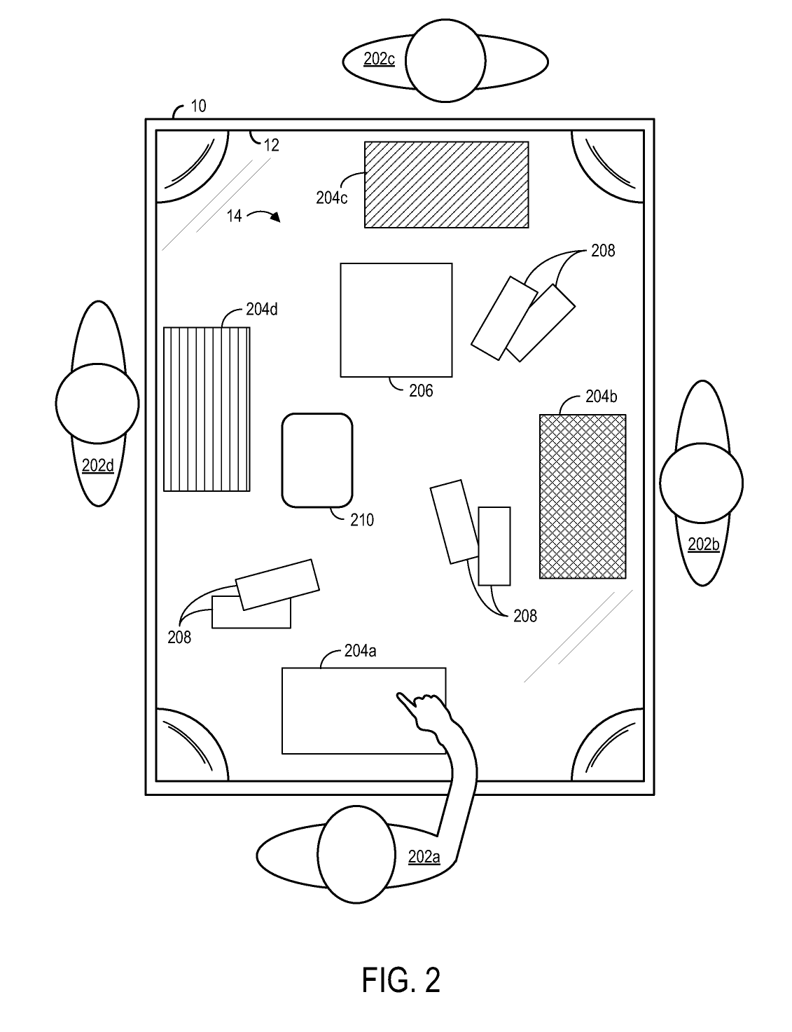

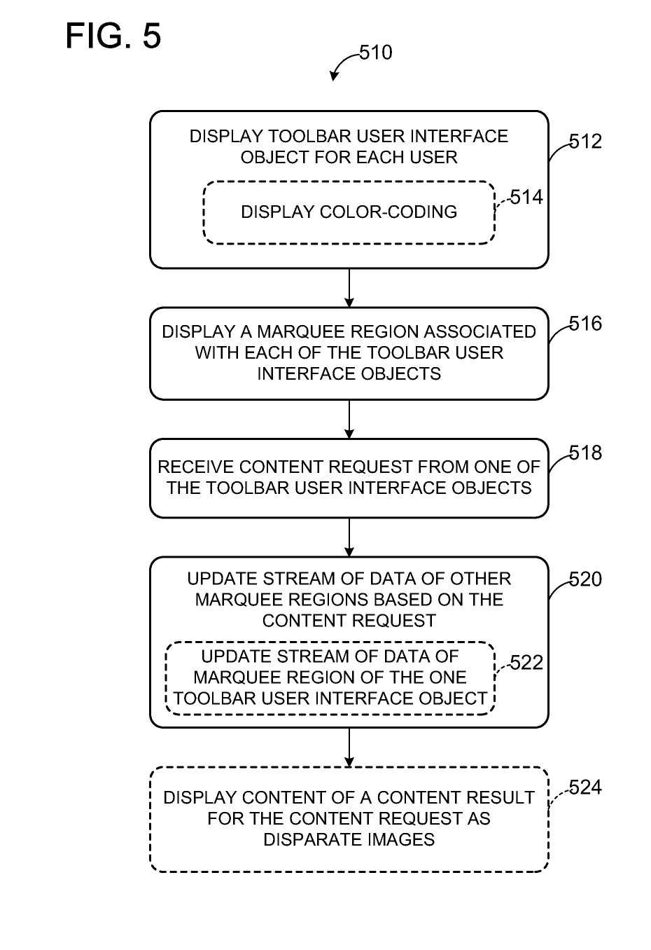

FIG. 2 schematically illustrates an example of collaborative search and share for the computing system 10. Here, an embodiment of the GUI 14 may be presented on the display 12. A plurality of toolbar user interface objects (i.e., toolbars) 204 may be presented on the GUI 14 by the multi-user search module 20. The toolbars may provide various touch input controls discussed in greater detail with reference to FIG. 4. The toolbars may be displayed in response to initialization of the multi-user search module, and/or in response to other events, actions, etc. For example, a user may trigger presentation of the toolbars via a touch gesture, selection of a button, or through a keyboard command. The toolbars may be repositioned and re-oriented, for example, through direct-touch manipulations such as touch gestures.

Further, each toolbar may include a text field configured to open a virtual keyboard, for example in response to a touch input, enabling user-entry of uniform resource locators (URLs), query terms, etc. Each toolbar may be further configured to initiate one or more browser windows, such as browser window 206. As an example, the toolbar may include a touch-selectable virtual button (e.g., a “Go” button), that is configured to open a browser window upon being selected. Further, in some embodiments, the content of the browser window and/or type of browser window may be based on the text entered into the text field. For example, if the terms entered into the text field begin with “http” or “www,” the browser window may be configured to open to a web page corresponding to that URL. As another example, if search terms are entered into the text field, then the browser window may be configured to open to a search engine web page containing search results for the search terms.

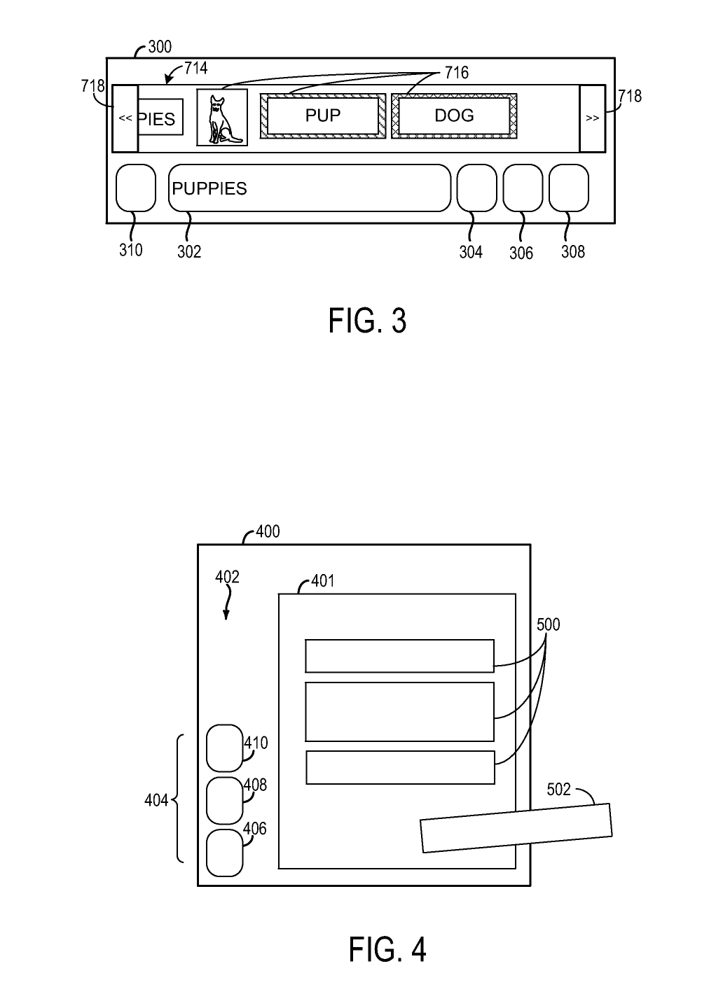

Each toolbar may be further configured to include a marquee region. The marquee region is configured to display a stream of data reflecting user activity of the other toolbars. As such, a user can remain informed about what her other user-group members are doing, such as searches performed, results obtained, keywords, utilized, and the like. In some embodiments, a toolbar's marquee region may also display activity associated with the toolbar itself. Marquee regions are discussed in more detail with reference to FIG. 3.

Continuing with FIG. 2, such toolbars may be variously displayed on display 12. As an example, one toolbar may be displayed per user-group member in the case where the users are co-located. In the case of four users positioned at the four sides of a horizontal multi-touch table, each toolbar may be aligned along an edge of the GUI corresponding to a side of the table. As an example, FIG. 2 depicts a first toolbar 204a corresponding to a first user 202a, a second toolbar 204b corresponding to a second user 202b, etc. Each toolbar is capable of receiving touch inputs. Further, each toolbar may be configured to visually indicate that the toolbar is associated with a particular user. For example, the toolbars may be color coded, allowing each user to differentiate their respective toolbar. Other aspects of the toolbar's appearance (e.g., size, geometry, regions of display, a photo of the user, an icon, etc.) may be used to facilitate differentiation between each user's toolbar and each user's search activities. The appearance of the different toolbars may be similar to one another in some embodiments. The toolbars 204 may be repositioned and re-oriented through direct-touch manipulations, and/or the position and/or orientation of the toolbars may be fixed.

As introduced above, browser windows 206 may also be presented on the GUI 14. The browser windows may include various tools that enable network navigation, the viewing of web pages and other network content, and the execution of network-based applications, widgets, applets, and the like. The browser windows may be initiated by the toolbars, and are discussed in more detail with reference to FIG. 4.

Disparate image clips (i.e., content clips) 208 may also be presented as part of the GUI. Clips 208 may include images of search results and other such content produced via the toolbars. Clips 208 may originate from a browser which divides the current web page into multiple smaller chunks. Thus, the clips can contain chunks of information, images, etc. from the search results. Since each disparate clip is capable of being displayed, manipulated, etc. independent of the source and/or other clips, the clips allow for search results to be easily disseminated amongst the group members. The ability to divide a page into clips supports division of labor and readability by enabling different group members to claim responsibility over distinct portions of a page's contents. The clips can then be individually rotated into a proper reading orientation for a particular user. Clips can also support clutter reduction since the small chunks of relevant content can remain open on the display and the parent page can be closed. Clips can be moved, rotated, and scaled in the same manner as browser windows. A user can also augment a clip with tags containing keywords, titles, notes, etc. Clips and tags are discussed in greater detail with reference to FIG. 4.

It can be appreciated that any actions, items, etc. described herein with respect to an interface object (e.g., a search request submitted via a toolbar, a clip originating from a toolbar, a search request received by a container, etc.) may be implemented by instructions executed by the computing system. Such instructions may be associated with the interface object and/or shared instructions providing functionality to a range of different computing objects.

The computing system may be configured to automatically associate several types of metadata with each clip, including, but not limited to, the identity of the user who created the clip; the content type of the clip (text, image, etc.); the URL of the web page the clip is from; the timestamp of the clip's creation; the tags associated with the clip; and/or the query keywords used to find the clip (or to find its parent web page).

It will be appreciated that each toolbar's color and/or other visual attributes may correspond to other content generated by or associated with the toolbar, as described in more detail below. In this way, each group member may be able to easily recognize which user is responsible for any particular content, browser, clips, etc.

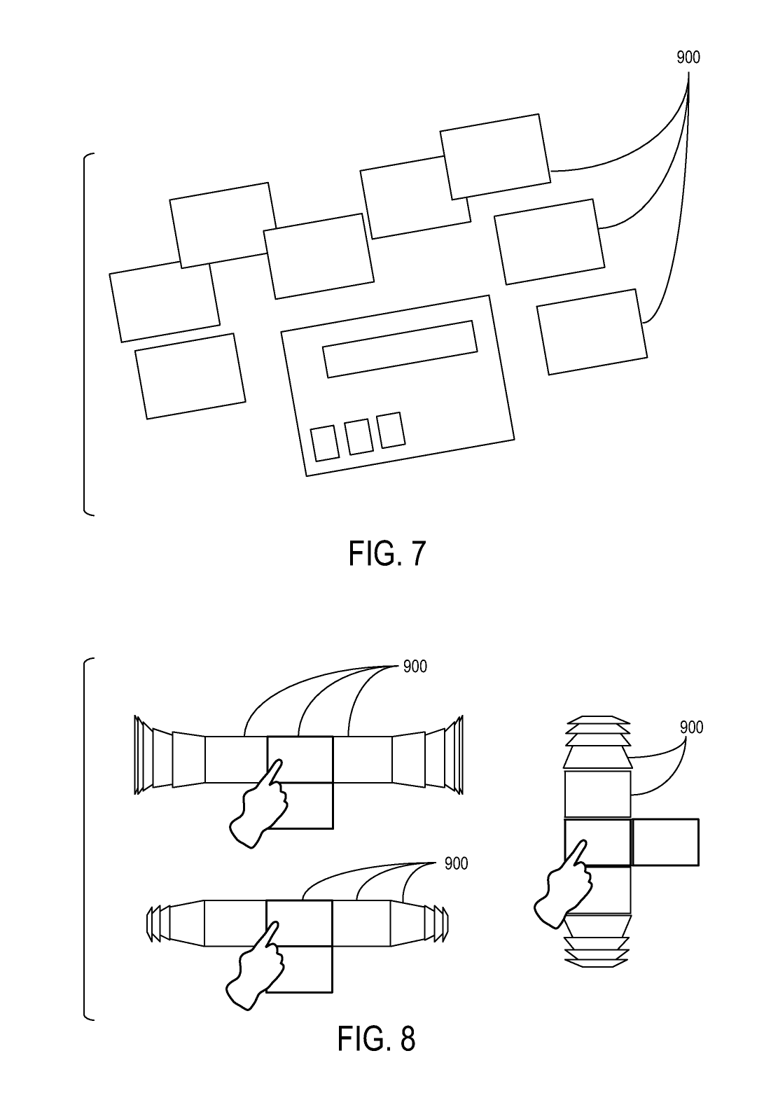

FIG. 2 also shows an example container 210 for organizing clips from the various users. Such a container is further configured to perform a “search-by-example” query based on the contents of the container, as described in more detail with reference to FIG. 6.

Turning now to FIG. 3, FIG. 3 shows an example toolbar user interface object (i.e., toolbar) 300. Toolbar 300 includes various elements that allow a user to quickly and efficiently conduct a search; organize and manipulate content such as text, images, and videos; and/or collaborate with members of the user-group.

Toolbar 300 may include a text field 302. The text field allows a user to input alpha-numeric symbols such as search or query terms, a URL, etc. It will be appreciated that the text field 302 may be selected via a user input (e.g., a touch input, a pointer-based input performed with an input device, etc.). In some examples, a virtual keyboard may be presented on the GUI in response to selection of the text field 302. In other examples, text may be entered into the text field 302 via a keyboard device or via a voice recognition system.

In some examples, selecting (e.g., tapping) a button 304 (e.g., a “go” or “enter” button) on the toolbar 300 may open a browser window. If a URL is entered into the text field 302 (e.g., text field begins with “http,” “https,” “www,” or another URL prefix), the browser window may show a web page located at that URL. If query terms are entered into the text field (e.g., text field does not begin with recognized URL prefix), the browser window may show a search engine page with results corresponding to the query terms. As shown, the toolbar may include a “clips” button 306, a “container” button 308, and a “save” button 310, each of which is discussed in greater detail with reference to FIG. 6.

Toolbar 300 may also include a marquee region 714. The marquee region 714 may include a plurality of marquee items 716. Each marquee item 716 may include graphical elements such as text, images, icons, etc., that reflect the various user-group member activities. These activities may result in creation of one or more of the following: query terms, titles of pages opened in browsers, and clips, for example. The marquee's content may be generated automatically based on one or more user actions. The color of at least a portion of each marquee item included in the plurality of marquee items 716, such as the marquee item's border, may correspond to an associated user and their activities. For example, the border of a clip generated by the member having a blue toolbar may be blue. It will be appreciated that other graphical characteristics of the marquee item (e.g., geometry, size, pattern, icons, etc.) may be used to associate a clip with a particular user and/or toolbar. As such, the marquee region facilitates awareness and readability.

Further, the marquee region 714 may be dynamic such that each marquee item in the marquee region may move across the marquee region. For example, the marquee region may be configured to visually display a slowly flowing stream of text and images that reflect the group members' activities, such as query terms (i.e., search terms) used, titles of some or all pages opened in browsers, and clips created.

The marquee region 714 may also provide scroll buttons 718. In the depicted embodiment, the scroll buttons 718 are provided at either end of the marquee region and are configured to allow a user to manually scroll to different marquee items. The scroll buttons may be positioned in another suitable location. Such scroll buttons may further enable the user to manually rewind or fast-forward the display, in order to review the content. As such, the marquee region of each user's individual toolbar facilitates awareness of group member activities. Further, the marquee region also addresses the challenge of reading text at odd orientations (e.g., upside down) by giving each group member a right-side-up view of key bits of information associated with other team members.

Further, the marquee items may be configured for interactivity. For example, a user may press and/or hold a marquee item causing the corresponding original clip or browser window to become highlighted, change colors (e.g., to the color of the toolbar on which the marquee item was pressed), blink, or otherwise become visually identifiable. This may simplify the process of finding content within a crowded user interface.

Marquee items and clips also provide another opportunity to reduce the frustration that may result from text entry via a keyboard (e.g., virtual keyboard). For example, a user may drag items out of the marquee onto the toolbar's text entry area in order to re-use the text contained in the marquee item (e.g., for use in a search query). Clips may also be used in a similar manner. For example, the “keyword suggestion” clips created by a “clip-search” can be dragged directly onto the text entry area (e.g., text field) in order to save the effort of manually re-typing those terms. Keyword suggestion clips and clip-searches are described in more detail with reference to FIG. 6.

Turning now to FIG. 4, FIG. 4 depicts a browser window 400 displaying search results 401. The borders 402 of browser window 400 may be augmented to include buttons 404. The buttons may include a “link” button 406, a “clips” button 408, and a “pan” button 410, for example. The buttons 404 allow a user to select various input modes (i.e., a “link” mode, a “clips” mode, and a “pan” mode), discussed in more detail below. In particular, the buttons may be held with one hand, triggering an input mode, while other elements in the browser window are manipulated with another hand. Thus, an input mode may be triggered when a user's hand (e.g., finger) comes into contact with a surface of the display associated with a particular button and the input mode may be discontinued when the user's hand (e.g., finger) is removed from the surface of the display. In this way, visual and tactile cues help a user recognize the input mode in which the system is operating, thereby reducing input error. In some examples, the input mode may be triggered after the user's hand is removed from the surface of the display. Further, in some examples, the aforementioned input modes (i.e., the “link” mode, the “clips” mode, and the “pan” mode) may be triggered through gestural or pointer-based input. In can be appreciated that alternatively, such input modes may be selected via touch gestures rather than the aforementioned buttons.

In the “pan” mode, a user may perform touch inputs to horizontally and vertically scroll content presented in the browser window. Thus, horizontal and vertical scrolling may be accomplished by holding the “pan” button with one hand while using the other hand to pull the content in the desired direction. As previously discussed, alternate input techniques, such as pointer-based inputs or gestural inputs, may be utilized to trigger the “pan” mode and/or scroll through the content.

In the “link” mode, web links presented in the browser window may be selected via touch input. For example, a user may hold the link button with one hand and tap the desired link with the other hand. Thus, in the “link” mode touch inputs may be interpreted as clicks rather than direct touch manipulation (e.g., move, rotate, scale, etc.). As previously discussed, alternate input techniques, such as pointer-based inputs or gestural inputs, may be utilized to trigger the “link” mode and/or select the desired links.

In the “clip” mode, the content presented in the browser window may be divided into a plurality of smaller portions 500. For example, text, images, videos, etc. presented in the browser window may each form separate portions. After the “clip” mode is triggered, a user may select (e.g., grab) one of the smaller portions (e.g., portion 502) and drag it beyond the borders of the browser window where the portion becomes a separate entity herein referred to as a disparate image clip (i.e., a clip, content clip, etc.). In some examples, when the “clip” mode is disabled the browser window returns to its original undivided state.

The computing system may be configured to create clips in any suitable manner. As one example, the multi-user search module may divide a page into clips automatically based on a document object model (DOM). For example, the multi-user search module may be configured to parse the DOM of each browser page when it is loaded. Subsequently, clip boundaries surrounding the DOM objects, such as paragraphs, lists, images, etc., may be created. As another example, a page may be divided into clips manually, for example, by a user via an input device (e.g., a finger, a stylus, etc.) by drawing on the page to specify a region of the page to clip out. It can be appreciated that these are just a few of many possible ways for clips to be generated.

Further, content clips may be displayed so as to visually indicate from which toolbar they originated. For example, if the toolbars are color-coded, then clips may be displayed with a same color coding. For example, all clips resulting via searches on the red toolbar may appear with a red indication on the clip.

The ability to divide a page presented in a browser window into clips supports division of labor and readability by enabling different group members to claim responsibility over distinct portions of a page's contents. Once divided, the clips can then be individually moved, scaled, and/or rotated into a proper reading position and orientation for a particular user. Clips may also support clutter reduction. For example, the smaller portions of relevant content may remain open on the GUI after the parent page is closed. It will be appreciated that the clips generated (e.g., captured) on the GUI may be transferred to separate computing systems or supplementary displays. In this way, a user may transfer work between multiple computing systems.

Further, as briefly introduced above, in some embodiments, clips may be tagged with keywords, titles, descriptions, etc. As an example, a clip may include a “tag” button, wherein selection of the “tag” button enables a tag mode in which clips may be augmented with tags. In some embodiments, a virtual keyboard may be opened in response to selection of the “tag” button. The tags associated with the clips may be displayed on the clip in the color corresponding to the user whom entered the tag. However, tags may not be color coded in all embodiments. Entering or augmenting clips may support sensemaking.

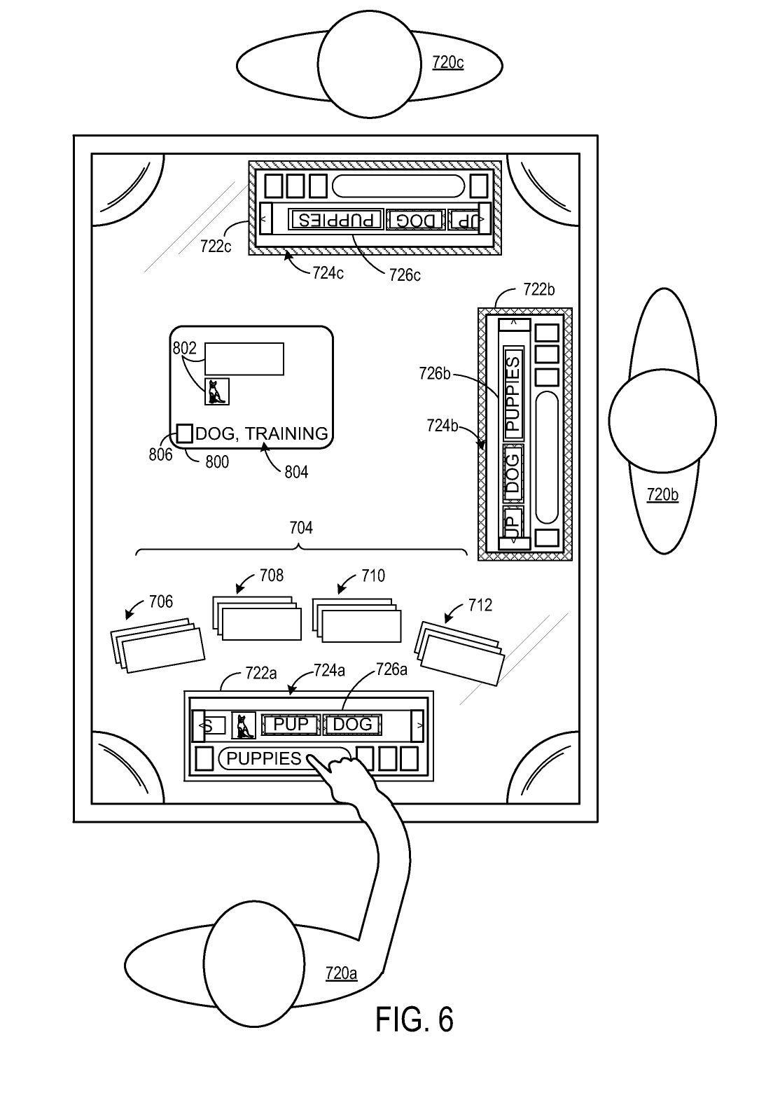

FIG. 5 shows a flow diagram of an example method 510 of facilitating collaborative content-finding. In some embodiments, collaborative content-finding may include collaborative searching, for example, using a search engine to request content. However, in some embodiments, collaborative content-finding may include accessing content without performing a keyword search. As an example, a user may request content directly by entering a URL. At 512, method 510 includes displaying a toolbar user interface object for each user, where each toolbar is configured to receive user inputs. For example, this may include displaying a first toolbar user interface object at a first input display area, a second toolbar user interface object at a second input display area, an n^{th} toolbar user interface object at an n^{th} input display area, etc. In some embodiments, the input display areas may be on different displays. However, in some embodiments, the users may be, for example, co-located at a same display of a computing device, such that the input display areas are on the same display. As an example, FIG. 6 shows co-located users 720 and corresponding toolbars 722 (i.e., user 720a and toolbar 722a; user 720b and toolbar 722b, etc.). However, in some embodiments, the users may not be located at the same device. It can be appreciated that FIG. 6 illustrates an example of input display areas in the form of touch display areas that are configured to directly receive input in the form of user touch. However, this example is nonlimiting—in some embodiments input display areas may be of a different type. The toolbar may be configured to detect any suitable type of user input, including but not limited to, touch inputs, 2-D and/or 3-D touch gestures, pen inputs, voice inputs, mouse input, etc.

Returning to FIG. 5, in some embodiments, displaying the toolbars may include, as indicated at 514, displaying the toolbars so as to visually indicate that each toolbar corresponds to a particular user. For example, the toolbars may be color-coded. However, it can be appreciated that any other visual indicator may be utilized. In the example of FIG. 6, toolbar 722a has a visual indication 724a, toolbar 722b has a different visual indication 724b, and toolbar 722c has yet a different visual indication 724c.

Returning to FIG. 5, at 516, method 510 includes displaying a marquee region associated with each of the toolbar user interface objects. The marquee region may be configured to display a stream of data reflecting user activity of the other toolbars, as described above.

At 518, method 510 includes receiving a content request via one of the toolbars. For example, a content request may be received via a text entry field. Examples of a content request include a search request, an address (e.g., URL), etc. In the example of FIG. 6, toolbar 722a has a marquee region 726a, toolbar 722b has a marquee region 726b, and toolbar 722c has a marquee region 726c. In the depicted example, a content request in the form of a search request of “puppies” may be received via toolbar 722a.

Returning to FIG. 5, at 520, method 510 includes updating the stream of data of other marquee regions based on the content request. In the example of FIG. 6, upon receiving the content request, marquee regions 726b and 726c may be updated to show the marquee item of “puppies.” In the depicted example, the marquee item of “puppies” is displayed with a visual indicator (e.g., a color-coded border) to identify the source of the marquee item as toolbar 722a.

In some embodiments, the marquee region may be further configured to reflect user activity of the user's own toolbar in addition to activity on other toolbars. In such cases, method 510 may further include updating the stream of data on the marquee region associated with the same toolbar that submitted the content request, as indicated at 522.

At 524, method 510 includes displaying content of a content result for the content request as disparate images (i.e., content clips). As introduced above, clips can contain chunks of information, images, etc. from the content results, and can be displayed, manipulated, etc. independent of the source of the content results and/or other clips. Whereas traditional content results produced by a web search engine, or content on a website, are typically displayed in a single browser window, clips allow for content results to be easily disseminated amongst the group members since each disparate clip is a distinct displayable item. In other words, clips may be virtually disseminated amongst the group just as index cards, etc. might be physically distributed to group members. As a nonlimiting example, the content result may include a web page, such that the content clips are different portions of the web page. In some embodiments, content results may be divided into several clips, as shown in FIG. 4, so that the clips can easily be distributed, for example via drag-and-drop placement to other group members, thus facilitating division of labor.

In some embodiments, the content clips visually indicate the toolbar user interface object that initiated the content request. For example, if each toolbar user interface object is displayed in a color-coded manner, the user activity of that toolbar user interface object is also displayed in a same color coding. Thus, content clips may be color coded to identify which toolbar created those clips. As another example, the user activity displayed in the stream of data of the marquee region of each of the toolbar user interface objects may also be color-coded, so each user can identify the source of the marquee items being displayed in their marquee.

However, in some embodiments, the computing system may automatically divide the clips into several piles of clips, and display each pile of clips near a user. In some cases, the piles may each correspond to a different type of clips. Such an approach also facilitates division of labor. In such a case, collaborative search and share may further provide for dividing content results for the content request into a plurality of disparate image clips (i.e., content clips), forming for each of the two or more co-located users a set of piles of disparate image clips comprising a subset of the plurality of disparate image clips, and displaying for each of the two or more co-located users the set of piles of disparate image clips corresponding to that user.

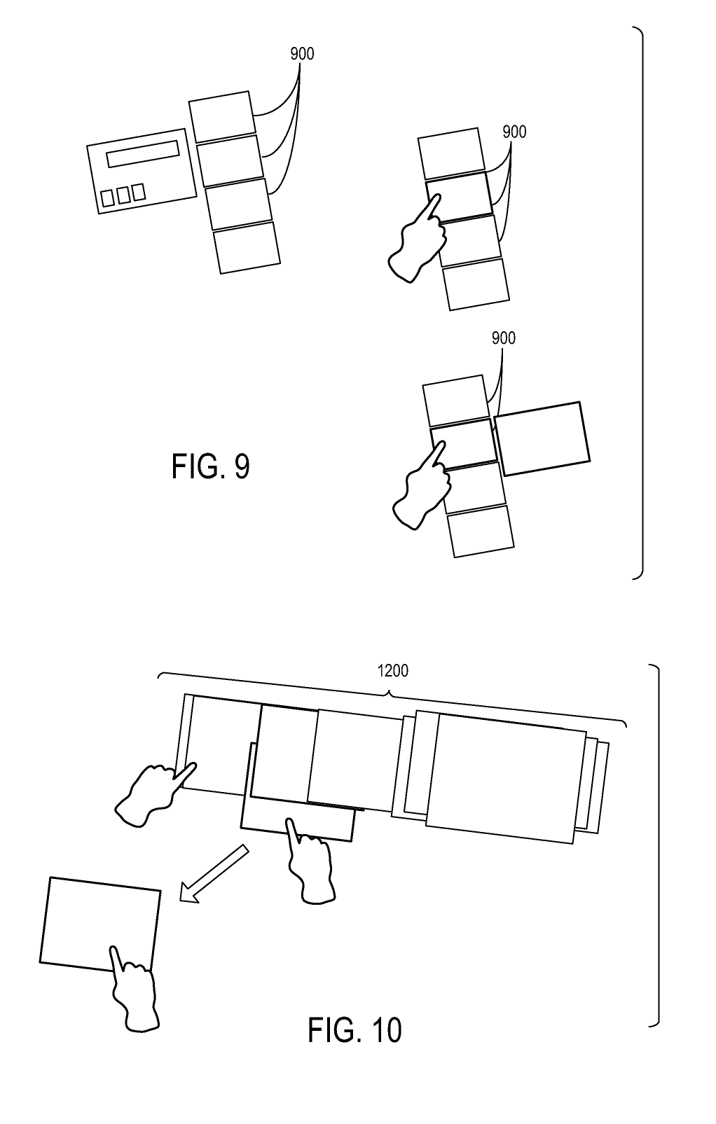

As a nonlimiting example, a user may select the “clips” button presented in a toolbar in lieu of the “go” button after the user has entered query terms into the toolbar. Selection of the “clips” button may send the query to a search engine (e.g., via a public application program interface (API)) and automatically create a plurality of clips adjacent to the user, such as clips 704 in FIG. 6. A “clips-search” is an example of such a search. The clips may be sorted into various categories, and each category of clips may be displayed in a pile. For example, as depicted in FIG. 7, a first pile of clips 706 may contain the most relevant images for the query, a second pile of clips 708 may contain snippets describing related web pages, a third pile of clips 710 may contain news article summaries on the query topic, and a fourth pile of clips 712 may contain suggested related query keywords. However, in other examples, alternate or additional piles of clips may be created in response to selection of the “clips” button. It will be appreciated that each pile may include a set of clips. The piles may be moved (i.e., via tap and drag) from one area of the display to another area of the display. This technique allows each user to take responsibility for different types of content, thereby providing another easy way for groups of users to divide labor tasks.

Collaborative search and share further provides containers within which clips may be organized. It will be appreciated that a user may generate a container through user input. Additionally or alternatively, one or more empty container(s) may be automatically generated in response to creation of a toolbar. Each container may be configured to organize a subset of the clips resulting from a search request. Further, the content (i.e., clips) included in the container may be searchable. Each clip in the container may be formatted for easy reading. Further, a user may send collections of clips in a readable format to a third party via email and/or another communication mechanism.

An example container 800 is shown in FIG. 6. It will be appreciated that a container may be created in response to selection of a “container” button such as button 308 shown in FIG. 3, for example. The container 800 includes a set of clips 802 arranged in a list. Other types of containers may organize clips in a different manner, such as in lists, grid/cluster views or in a free form positioning. Further, virtual keyboards may be used to specify a title for the container.

The container may also be translated, rotated, and scaled through direct manipulation interactions (e.g., touch or pointer based input). Clips may be selectively added or removed from the container via a drag-and-drop input. As such, containers facilitate collection of various material from disparate websites, for a multi-user, direct manipulation environment.

The container 800 may also be configured to provide a “search-by-example” capability in which a search term related to a group of clips included in the container is suggested. As such, containers provide a mechanism to facilitate discovery of new information. The search-by-example query may be based on a subset of the two or more disparate image clips within the container (i.e., one or more of the clips). Suggested search terms 804 may be displayed within the search window, providing the user with examples of search terms automatically generated based on the contents (e.g., text, metadata, etc.) of the corresponding clips. The search may be responsive to the container receiving a search command, such as tapping on the container, pressing a button on the container, etc. As an example, selecting a “search” button 806 may execute a search using the suggested search terms. Search results derived from such a search may be opened in a new browser window. Other suitable techniques may additionally or alternatively be used to execute a search using a search-by-example query.

The suggested search terms may optionally be updated every time a clip is added to or removed from the container. It will be appreciated that the search preview region may be updated based on alternative or additional parameters, such as at a predetermined time interval. As an example, in response to receiving an input adding another clip to the container, the container may be configured to execute another search-by-example query based on the updated contents.

The suggested search terms may be generated by analyzing what terms a group of clips has in common (optionally excepting stopwords). If there are no common terms, the algorithm may instead choose one or more salient terms from one or more clips, where saliency may be determined by heuristics including the frequency with which a term appears and whether the term is a proper noun, for example. This functionality helps to reduce the need for tedious virtual keyboard text entry. It will be appreciated that alternate techniques may be utilized to generate the suggested search terms.

As introduced above, the stream of data displayed within each marquee region includes user-selectable marquee items. As such, a computing system providing collaborative search and share may be configured to receive selection of a marquee item for drag-and-drop placement into a search region of the toolbar user interface object associated with the marquee region. In other words, the computing system is configured to recognize a user's selection of a marquee item in a marquee, and recognize an indication that the marquee item is to be used as an input for a search request.

Search results may be displayed in several ways on a GUI. For example, each search result may be displayed on a search result card. In this way, a user can physically divide the search results for further exploration (e.g., by moving and/or rotating the various cards in front of different users sharing a tabletop, multi-touch computing system). The aforementioned scenario (e.g., “a divide and conquer scenario”) further allows the division of labor among users at the table. As such, collaborative search and share may further provide for dividing search results for the search request into a plurality of displayable search results cards, where each search results card is associated with one of the search results and includes a search result link and a description corresponding to the search result.

FIGS. 7-9 show various exemplary groupings of search result cards 900 generated in response to a search performed using a toolbar or a search window. Each search result card may include a title, a search result link, text, and/or pertinent graphical information included in a search result. A user may sort through the search results via touch input or other suitable forms of user input.

As shown in FIG. 7, the search result cards may be presented in a grid/cluster configuration. In such a grid/cluster, the individual cards may be moved and/or rotated independently. As shown in FIGS. 8 and 9, the search result cards may be grouped in a stack or a list (i.e., a carousel view). As such, collaborative search and share may further provide for displaying the plurality of search results cards in a carousel view, where the carousel view provides a user interface that is vertically or horizontally scrollable via touch gesture inputs to scroll through the plurality of search results cards.

In such a stack or list, a particular card may be brought into focus while other cards are made less prominent. In this way, a relatively large number of cards can be navigated. In some embodiments, collaborative search and share may provide for recognizing a touch gesture from one of the two or more co-located users selecting one of the plurality of search results cards displayed in the carousel view, and in response, displaying on the touch display a virtual sliding of the selected one of the search results cards to another of the two or more co-located users.

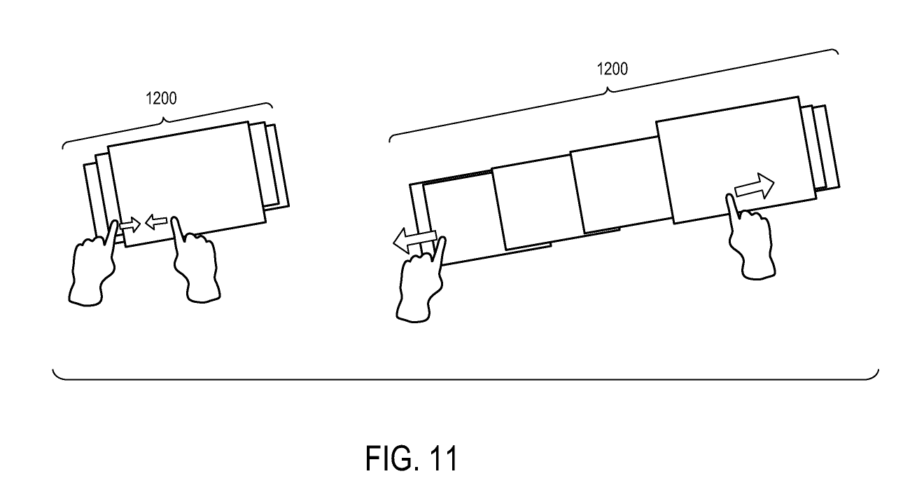

As shown in FIGS. 10 and 11, a travel log 1200 may be presented on a GUI. The travel log may include the history of web pages visited. Collaborative search and share may therefore provide for creating a travel log associated with each of the toolbar user interface objects, where the travel log indicates a history of searches performed via that toolbar user interface object. Each web page may be assigned a z-order based on an order in which the page was viewed. For example, recently viewed pages may be given a higher z-order. Other suitable arrangement schemes may be used in some embodiments. The travel log may be automatically presented on the display during a search session, or the travel log may be presented on the GUI in response to input from a user (e.g., triggering a button, inputting a key command, a touch gesture, etc.).

The travel log may be manipulated through various touch input gestures, such as the expansion or contraction of the distance between two touch points. It will further be appreciated that the arrangement (e.g., z-order) of the travel log may be re-arranged based on the user's predilection. The pages included in the travel log may be dragged and dropped to other locations on the GUI. For example, other users included in the user-group may pull pages from another user's travel log and create a copy of the page in their personal travel log. In this way, users can share web sites with other users, and/or lead other users to a currently viewed site.

In some embodiments, collaborative search and share may provide for creating a group activity log indicating user activity of each of the toolbar user interface objects. Such a search session record may be exported by the multi-user search module. The search session record may optionally be exported in an Extensive Markup Language (XML) format with an accompanying spreadsheet formatted file, enabling a user to view the record from any web browser application program for post-meeting reflection and sensemaking. In some embodiments, the metadata associated with the clips is used to create the record of the group's search session. In some embodiments, pressing a “save” button on a toolbar creates this record, as well as creating a session file that captures the current application state, enabling the group to reload and resume the collaborative search and share session at a later time. This supports persistence by providing both persistence of the session for resumption by the group on the computing system at a later time, as well as persistence in terms of an artifact (the XML record) that can be viewed individually away from the tabletop computer. The metadata included in the record also supports sensemaking of the search process by exposing detailed information about the lineage of each clip (i.e., which group member found it, how they found it, etc.), as well as information about the assignment of clips to containers.

It is to be understood that the configurations and/or approaches described herein are exemplary in nature, and that these specific embodiments or examples are not to be considered in a limiting sense, because numerous variations are possible. As one example, the names of the particular buttons described above (e.g., “go,” “clips,” “pan,” “link,” etc.) are provided as nonlimiting examples. Other names may be used on buttons and/or virtual controls other than buttons may be used. As another example, while many of the examples provided herein are described with reference to a tabletop, multi-touch computing device, many of the features described herein may have independent utility using a conventional computing device.

The specific routines or methods described herein may represent one or more of any number of processing strategies. As such, various acts illustrated may be performed in the sequence illustrated, in other sequences, in parallel, or in some cases omitted. Likewise, the order of the above-described processes may be changed. Further, it can be appreciated that such instructions may be executed on a single computing device such as a multi-touch tabletop computing device, and/or on several computing devices that are variously located.

The terms “module” and “engine” may be used to describe an aspect of the computing system (e.g., computing system 10) that is implemented to perform one or more particular functions. In some cases, such a module or engine may be instantiated via a logic subsystem (e.g., logic subsystem 22) executing instructions held by a data-holding subsystem (e.g., data-holding subsystem 24). It is to be understood that different modules and/or engines may be instantiated from the same application, code block, object, routine, and/or function. Likewise, the same module and/or engine may be instantiated by different applications, code blocks, objects, routines, and/or functions in some cases.

The subject matter of the present disclosure includes all novel and nonobvious combinations and subcombinations of the various processes, systems and configurations, and other features, functions, acts, and/or properties disclosed herein, as well as any and all equivalents thereof.

1. A method of facilitating collaborative content-finding, comprising:
displaying at a first input display area a first toolbar user interface object, the first toolbar user interface object associated with a first user and capable of receiving user inputs;
displaying at a second input display area a second toolbar user interface object, the second toolbar user interface object associated with a second user and capable of receiving user inputs;
displaying at the first input display area a first marquee region associated with the first toolbar user interface object, the first marquee region configured to display a stream of data reflecting user activity of the second toolbar user interface object;
displaying at the second input display area a second marquee region associated with the second toolbar user interface object, the second marquee region configured to display a stream of data reflecting user activity of the first toolbar user interface object;
receiving a content request via the first toolbar user interface object;
updating the stream of data displayed at the second marquee region based on the content request; and
displaying content of a content result for the content request as two or more disparate images.

2. The method of claim 1, where the first user and the second user are co-located at a touch-display computing device and where the first input display area and the second input display area are on a same touch display of the touch-display computing device.

3. The method of claim 1, where the content of the content result includes a web page and where the two or more disparate images comprise different portions of the web page.

4. The method of claim 1, where the stream of data displayed at the first marquee region further reflects user activity of the first toolbar user interface object and where the stream of data displayed at the second marquee region further reflects user activity of the second toolbar user interface object.

5. A method of facilitating collaborative searching on a touch-display computing device having two or more co-located users, the method comprising:
displaying on a touch display of the touch-display computing device a toolbar user interface object for each of the two or more co-located users, each toolbar user interface object capable of receiving touch inputs;
displaying on the touch display a marquee region associated with each of the toolbar user interface objects, each marquee region displaying a stream of data reflecting user activity of all other toolbar user interface objects;
receiving a search request via one of the toolbar user interface objects; and
updating the stream of data of the marquee region of each of the other toolbar user interface objects based on the search request.

6. The method of claim 5, further comprising dividing search results for the search request into two or more disparate image clips and displaying the two or more disparate image clips on the touch display.

7. The method of claim 6, further comprising organizing a subset of the two or more disparate image clips into a container, the container configured to execute a search-by-example query based on the subset of the two or more disparate image clips within the container responsive to the container receiving a search command.

8. The method of claim 7, further comprising receiving an input adding another disparate image clip to the container, and in response, executing a search-by-example query based on an updated subset of the two or more disparate image clips within the container.

9. The method of claim 5, further comprising dividing search results for the search request into a plurality of disparate image clips, forming for each of the two or more co-located users a set of piles of disparate image clips each comprising a subset of the plurality of disparate image clips, and displaying for each of the two or more co-located users the set of piles of disparate image clips corresponding to that co-located user.

10. The method of claim 5, further comprising dividing search results for the search request into a plurality of displayable search results cards, each search results card associated with one of the search results and comprising a search result link and a description corresponding to the search result.

11. The method of claim 10, further comprising displaying the plurality of search results cards in a carousel view, the carousel view providing a user interface that is vertically or horizontally scrollable via touch gesture inputs to scroll through the plurality of search results cards.

12. The method of claim 11, further comprising recognizing a touch gesture from one of the two or more co-located users selecting one of the plurality of search results cards displayed in the carousel view, and in response, displaying on the touch display a virtual sliding of the selected one of the search results cards to another of the two or more co-located users.

13. The method of claim 5, further comprising creating a travel log associated with each of the toolbar user interface objects, the travel log indicating a history of searches performed via that toolbar user interface object.

14. The method of claim 5, further comprising creating a group activity log indicating user activity of each of the toolbar user interface objects.

15. The method of claim 5, where the stream of data displayed within each marquee region includes user-selectable marquee items, each marquee item capable of being selected by one of the two or more co-located users for drag-and-drop placement into a search region of the toolbar user interface object associated with the marquee region.

16. The method of claim 5, where each marquee region is further configured to display a stream of data reflecting user activity of the toolbar user interface object associated with that marquee region.

17. The method of claim 5, where each toolbar user interface object and user activity of that toolbar user interface object are displayed in a color coding associated with one of the two or more co-located users, and where the stream of data of the marquee region of each of the toolbar user interface objects is configured to display user activity in accordance with the color coding.

18. A collaborative search system for a touch-display computing system having two or more co-located users, comprising:
a touch display;
a logic subsystem to execute instructions;
a data-holding subsystem holding instructions executable by the logic subsystem to:
display on the touch display a toolbar user interface object for each of the two or more co-located users, each toolbar user interface object visually indicating that the toolbar user interface object is associated with a different user of the two or more co-located users and each toolbar user interface object capable of receiving touch inputs;
receive a search request via one of the toolbar user interface objects; and
display content of a search result for the search request as one or more content clips, each content clip visually indicating the one of the toolbar user interface objects that initiated the search request.

19. The collaborative search system of claim 18, where the instructions are further executable to display on the touch display a marquee region for each of the toolbar user interface objects, each marquee region displaying a stream of data reflecting user activity of all other toolbar user interface objects.

20. The collaborative search system of claim 19, where the instructions are further executable to display each toolbar user interface object and user activity of that toolbar user interface object in a color coding associated with one of the two or more co-located users, and to display user activity in the stream of data of the marquee region of each of the toolbar user interface objects in accordance with the color coding.
